(19) United States
(12) Patent Application Publication
(10) Pub. No.: US 2009/0070380 A1
(43) Pub. Date: Mar. 12, 2009

(54) METHOD, SYSTEM, AND APPARATUS FOR ASSEMBLY, TRANSPORT AND DISPLAY OF CLINICAL DATA

(75) Inventors: Robert G. Schwager, Newtown, CT (US); Alwin B. Carus, Waban, MA (US); Harry J. Ogrinc, Medfield, MA (US); Jeffrey G. Hopkins, Lincoln, RI (US); Susan Reggie, White Plains, NY (US); David E. Pearah, Winchester, MA (US)

Correspondence Address: KELLEY DRYE & WARREN LLP, 400 ALTLANTIC STREET , 13TH FLOOR, STAMFORD, CT, 06901, US

(73) Assignee: Dictaphone Corporation, Stratford, CT (US)

(21) Appl. No.: 12/233,675

(22) Filed: Sep. 19, 2008

Related U.S. Application Data
(63) Continuation of application No. 10/948,625, filed on Sep. 23, 2004.
(60) Provisional application No. 60/505,428, filed on Sep. 25, 2003.
(60) Provisional application No. 60/507,136, filed on Oct. 1, 2003.
(60) Provisional application No. 60/507,135, filed on Oct. 1, 2003.
(60) Provisional application No. 60/507,134, filed on Oct. 1, 2003.
(60) Provisional application No. 60/506,763, filed on Sep. 30, 2003.
(60) Provisional application No. 60/533,217, filed on Dec. 31, 2003.
(60) Provisional application No. 60/547,801, filed on Feb. 27, 2004.
(60) Provisional application No. 60/547,797, filed on Feb. 27, 2004.

(51) Int. Cl. G06F 17/30

(52) U.S. Cl. 707/104.1; 707/E17.009

(57) ABSTRACT

The Clinical Data Container (CDC) is a method for packaging, transporting, and viewing medical reports, their associated data elements, images, and data from medical information systems for use by physicians and patients.

### CROSS-REFERENCE TO RELATED APPLICATIONS

This application is a continuation application of U.S. patent application Ser. No. 10/948,625 filed Sep. 23, 2004, which is a non-provisional application of U.S. Provisional Application No. 60/505,428, entitled “METHOD, SYSTEM, AND APPARATUS FOR ASSEMBLY, TRANSPORT AND DISPLAY OF CLINICAL DATA”, filed Sep. 25, 2003, both of which are hereby incorporated by reference in its entirety.

This application also relates to co-pending U.S. patent application Ser. No. 10/413,405, entitled, “INFORMATION CODING SYSTEM AND METHOD”, filed Apr. 15, 2003; co-pending U.S. patent application Ser. No. 10/447,290, entitled, “SYSTEM AND METHOD FOR UTILIZING NATURAL LANGUAGE PATIENT RECORDS”, filed on May 29, 2003; co-pending U.S. patent application Ser. No. 10/448,317, entitled, “METHOD, SYSTEM, AND APPARATUS FOR VALIDATION”, filed on May 30, 2003; co-pending U.S. patent application Ser. No. 10/448,325, entitled, “METHOD, SYSTEM, AND APPARATUS FOR VIEWING DATA”, filed on May 30, 2003; co-pending U.S. patent application Ser. No. 10/448,320, entitled, “METHOD, SYSTEM, AND APPARATUS FOR DATA REUSE”, filed on May 30, 2003, co-pending U.S. Provisional Patent Application 60/507,136, entitled, “SYSTEM AND METHOD FOR DATA DOCUMENT SECTION SEGMENTATIONS”, filed on Oct. 1, 2003; co-pending U.S. Provisional Patent Application 60/507,135, entitled, “SYSTEM AND METHOD FOR POST PROCESSING SPEECH RECOGNITION OUTPUT”, filed on Oct. 1, 2003; co-pending U.S. Provisional Patent Application 60/507,134, entitled, “SYSTEM AND METHOD FOR MODIFYING A LANGUAGE MODEL AND POST-PROCESSOR INFORMATION”, filed on Oct. 1, 2003; co-pending U.S. Provisional Patent Application 60/506,763, entitled, “SYSTEM AND METHOD FOR CUSTOMIZING SPEECH RECOGNITION INPUT AND OUTPUT”, filed on Sep. 30, 2003, co-pending U.S. Provisional Patent Application 60/533,217, entitled “SYSTEM AND METHOD FOR ACCENTED MODIFICATION OF A LANGUAGE MODEL” filed on Dec. 31, 2003, co-pending U.S. Provisional Patent Application 60/547,801, entitled, “SYSTEM AND METHOD FOR GENERATING A PHRASE PRONUNCIATION”, filed on Feb. 27, 2004, co-pending U.S. patent application Ser. No. 10/787,889 entitled, “METHOD AND APPARATUS FOR PREDICTION USING MINIMAL AFFIX PATTERNS”, filed on Feb. 27, 2004; co-pending U.S. Provisional Application No. 60/547,797, entitled “A SYSTEM AND METHOD FOR NORMALIZATION OF A STRING OF WORDS,” filed Feb. 27, 2004, and co-pending U.S. Provisional Application No. 60/505,428, field Mar. 31, 2004, and entitled “CATEGORIZATION OF INFORMATION USING NATURAL LANGUAGE PROCESSING AND PREDEFINED TEMPLATES”, all of which co-pending applications are hereby incorporated by reference in their entirety.

### BACKGROUND OF THE INVENTION

Current medical documentation practices geared to the capture and dissemination of clinical medical information have evolved over many generations. Before the advent and pervasive deployment of computer-based clinical systems, those procedures were largely limited to the construction and storage of physical, printed or written documents. Most doctors are familiar with, and comfortable with, an information workflow consisting of writing a note, putting the note in a folder, storing the folder in an archive room, and then later trying, often unsuccessfully, to find that written note.

Medical dictation, enabled by analog recording devices and later telephony systems, streamlined the medical documentation process to some extent. Rather than doctors having to write up extensive medical documents, those reports could now be sent to a transcription who would type up the physical document. Although a significant advance in the documentation process, the workflow is still document-centric and predominantly paper-based: type a document, sign a physical document, put it in the folder, store it, and try to retrieve it.

In the last 20-30 years, computers have played an ever increasing part in the capture and dissemination of clinical information. In many cases, however, even modern computer systems simply make that paper-based workflow more efficient. Advances include: semi-automatically constructing the documents using speech recognition; providing electronic signature capability for doctors to review and legally sign off on documents; routing, printing, and faxing documents automatically to interested parties; storing documents in some long-term archive; and retrieving documents from the archive. In many cases, the physical, printed document has been supplanted by its related electronic form, but the workflow is still largely identical to the original, paper-based workflows.

Even though the capture, storage, routing, and retrieval of electronic documents are superior in many ways to the classic, paper-based workflow, in one substantial way, computer-based workflows are still seriously lacking. That deficiency is squarely in the area of exposure and usage of the captured clinical information. Despite very elaborate workflows, computer-based systems and regulatory guidelines ensuring consistency across facilities, it is very difficult, and often impossible, to get that information to the doctor in a timely manner. Even when the information can be sent to the doctor quickly, the presentation is usually as an electronic document (i.e., an electronic version of a paper document); the doctor has to read the document or try to scan it for pertinent clinical data. The end result is that a vast store of clinical information is largely inaccessible to the doctor at the point of care wherever that may take place.

Electronic Medical Record systems (EMRs) promise to capture and store clinical information in a format that the computer can manipulate, allowing computers to process and route clinical information much more efficiently than most systems can do today. However, they do this by largely replacing the document-based workflows that physicians find most comfortable for data entry. Thus physician adoption of EMRs continues to be low. Additionally, EMRs are typically very expensive to buy, configure, and administer. Certainly EMRs will not supplant document-based medical systems in the short-term. The electronic medical document will be with us for a long time.

There have recently been initiatives to define a format for electronic documents that would make explicit the clinical data stored within medical documents. If such a format were widely adopted and its construction could be automated, medical systems could start to make sense of the wealth of information trapped in those systems without physicians having to radically change their dictation-based workflow. Unfortunately, no format has gained wide acceptance, and some of the formats that have achieved limited adoption, e.g., the HL7 Clinical Document Architecture (CDA) Level 1 XML standard, do not adequately address the identification of clinical data. Additionally, the automatic identification and normalization of clinical data within medical documents has until recently been an unrealizable dream. Some systems have recently emerged that can automatically identify and normalize clinical data, but then those systems are limited in that there exist no sufficient standards for communicating that information to other systems. Clearly a widely adopted format for clinical information that has been traditionally found in documents, images, and medical information systems is needed to fulfill the promise of quickly communicating relevant clinical information to healthcare providers.

Further, Continuity of Care Record (CCR) is a standard specification being developed jointly by ASTM International, the Massachusetts Medical Society (MMS), the Health Information Management and Systems Society (HIMSS), and the American Academy of Family Physicians (AAFP). It is intended to foster and improve continuity of patient care, to reduce medical errors, and to assure at least a minimum standard of health information transportability when a patient is referred or transferred to, or is otherwise seen by, another provider. The origins of the CCR stem from a Massachusetts Department of Public Health, three-page, NCR paper-based Patient Care Referral Form that has been in widespread use for many years in Massachusetts, and from other minimal data sets both electronic and paper-based.

The CCR is being developed and enhanced in response to the need to organize and make transportable a set of basic patient information consisting of the most relevant and timely facts about a patient's condition. Briefly, these include patient and provider information, insurance information, patient's health status (e.g., allergies, medications, vital signs, diagnoses, recent procedures), recent care provided, as well as recommendations for future care (care plan) and the reason for referral or transfer. This minimum data set will enhance the continuity of care by providing a method for communicating the most relevant information about a patient and providing both context and support for the electronic health record (EHR) through extensions.

However, there is currently no standard or mechanism for easily packaging, transporting, and viewing medical documents and their associated data elements to physicians and patients.

### SUMMARY OF THE INVENTION

The present invention includes a method, system and apparatus for packaging, transporting, and viewing medical reports, their associated data elements, images, and data from medical information systems for use by physicians and patients. Some embodiments may include a defined format for packaging a medical document, its associated facts, images, and data from medical information systems. Some embodiments may include a method for encapsulating, encrypting, and transporting these documents and data, and a method for decrypting and viewing the documents and data, both one at a time and in a longitudinal fashion.

In one aspect, the present invention is a method for distributing shared medical information, the method including the steps of obtaining a document processed through a natural language processing system, the document having corresponding associated medical facts; obtaining a healthcare information system data set; extracting a set of data elements from the document and its corresponding associated medical facts and from the healthcare information system data set according to first pre-defined standard; formatting the medical document into a second predefined standard; formatting the extracted data elements according to the first predefined standard; converting the formatted medical document and the formatted extracted data elements into a predefined application format; encrypting the application format; and distributing the application format.

In some embodiments, the first predefined standard may be the Continuity of Case Records (CCR) standard. In some embodiments, the second predefined standard may be the CDA standard.

In a second aspect, the present invention may include a method for distributing a document bundled with associated facts to a user, where the method includes selecting a document transcribed from an audio file created by the user, determining associated facts corresponding to the document, identifying images and data from other medical information systems to be encapsulated with the document and its associated facts, defining a single format suitable for packaging the document and the associate facts, encapsulating the document and the associated facts in the single format, encrypting and transporting the encapsulated document and associated facts to the user in a fashion suitable for singular or longitudinal viewing by the user.

In some embodiments the present invention may include collecting and storing CDCs in a repository, searching for CDCs in that repository by user-selected criteria, generating electronic and printed reports of the results of these searches, adding comments and other metadata, and encapsulating, encrypting, and transporting these customized CDCs.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the figures, wherein:

FIG. 1 shows a logical flow diagram of the system according to one embodiment of the present invention;

FIG. 2 shows representation of an NLPR processed document as it to the entire set of CCR facts according to one embodiment of the present invention;

FIG. 3 shows a representation of a CDC container according to one embodiment of the present invention;

FIG. 4 shows another representation of a CDC container according to one embodiment of the present invention;

FIG. 5 shows a representation of multiple encapsulated CDC containers according to one embodiment of the present invention; and

FIG. 6 shows a representation of an NLPR processed document as it relates to the entire set of CCR facts according to another embodiment of the present invention.

### DETAILED DESCRIPTION OF THE PREFERRED EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of network systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

The present invention includes a mechanism for packaging, transporting, and viewing individual documents and their associated data elements, primarily (but not exclusively) from the Natural Language Patient Record™ (NLPR) system sold by Dictaphone(r) Corporation. The users can be physicians who originally dictated the documents, referring physicians and consulting medical providers, and patients who are the subject of the dictation. The present invention advantageously provides documents and data in a portable fashion so that when a physician dictates a document within a hospital setting, the document and its associated data can be easily packaged and sent to them (via email, etc.) for later viewing within their private practice using a viewer or EMR, or immediately burned onto a mini-CD or other portable media and handed to a patient for later viewing on their PC.

The method according to the present invention includes packaging the document and data along with a run-time viewer, e.g., a viewer such as provided by Adobe, Inc. entitled Adobe Acrobat(r) Reader, that would contain basic viewing and search capability for one document at a time. Such a viewer may be made available to the physician and/or patient for either a minimal or no charge from the hospital. The present invention may advantageously provide increased sales of EWS/NLPR systems, and through the eventual up-sell of physicians to a practice-based system that would allow the aggregation and longitudinal viewing of CDC documents and data. Similarly, physicians and/or patients may be provided with a subscription to a hosted “portal” that may be used to view medical records in their entirety, and possibly could allow the user to add data to it (e.g., log information for critical conditions such as diabetes, etc.)

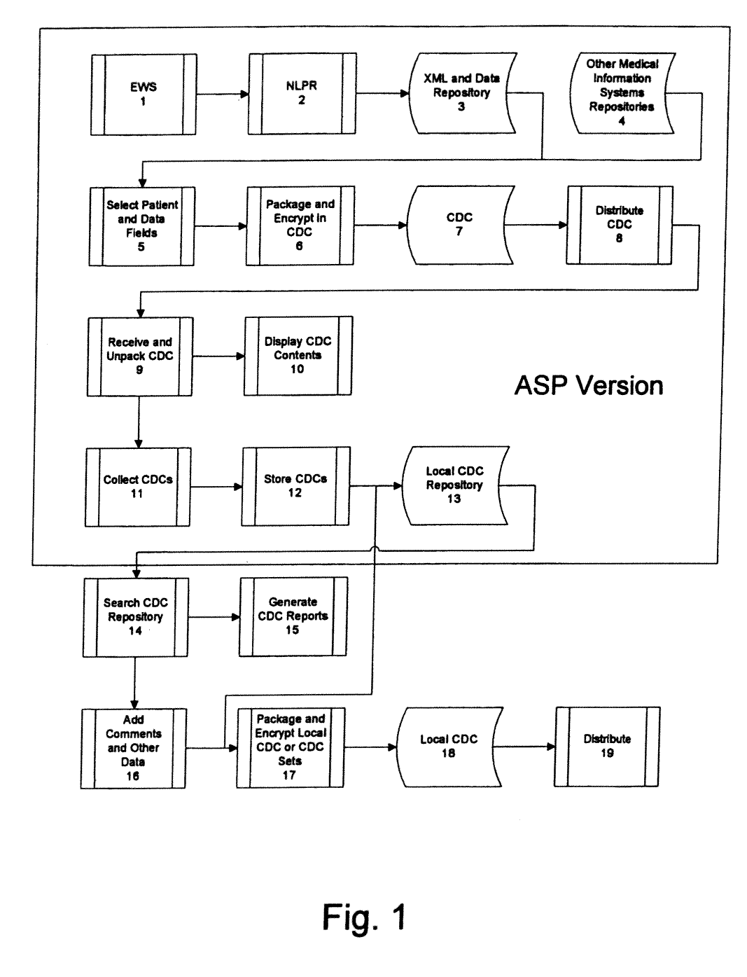

Referring now to FIG. 1 the system of the present invention is represented in a work flow diagram which may have the following logical flow elements and/or steps:

1. EWS—Enterprise Workstation

2. NLPR—Natural Language Processing Record

3. XML and Data Repository—Extensive Markup Language

4. Other Medical Information Systems Repositories

5. Selecting Patient and Data Fields

6. Packaging and Encrypting in the CDC

7. CDC

8. Distributing the CDC

9. Receive and Un-package the CDC

10. Displaying the CDC Contents

11. Collecting the CDCs

12. Storing the CDCs

13. Local CDC Repository

14. Search the CDC Repository

15. Generating the CDC Reports

16. Adding other Comments and Other Data

17. Packaging and Encrypting Local CDC or CDC Sets

18. Local CDC

19. Distributing the CDC.

In more detail and still referring to FIG. 1, reference number 1 refers to Enterprise Workstation (EWS), which is a Dictaphone Corporation system where medical report are created. It will be understood however by those skilled in the art that a generic source of medical documentation may be suitable without departing from the spirit and scope of the present invention. The reports from EWS 1 under go processing by Dictaphone's Natural Language Processing Record (NLPR) system as described in U.S. patent application Ser. No. 10/447,290 entitled “Systems and Methods for Utilizing Natural Language Patient Records: filed May 23, 2003, which is incorporated by reference herein in its entirety.

The NLPR system process the medical documentation and extract certain sections related to relevant subject matter and isolate clinical data items that are relevant to that document and then store such information data repository system or database 3 where the document and associated data would be stored and linked together ostensibly in accordance with NLPR. Data base 3 may be an XML repository. Repository 3 may be combined with information from other medical systems 4 to formulate a larger set of data. Patient data and data fields are selectively chosen 5, to form a query, obtain a result in a selection set of documents and data that you are relevant to capture and transfer to another system. Packaging and encrypting of the data or set of documents 6 allows you move the set of data in Clinical Data Container (CDC) 7. Distribution of the CDC 8 can be accomplished in any known format including, email, CD wireless transmission. When the CDC reaches a target system on the receiving end, the CDC is unpacked decrypted 9 in order to display the CDC contents 10. A collection of multiple CDCs 11, can be stored 12 in a local CDC repository 13. An example of a local repository may be using several documents dictated by a physician within a hospital and distributing those to local CDC system at a physician's local office or practice.

In box 14 the same physician may, for example and keeping with the example of the physician and their practice, search that CDC repository, identify a target selection set of documents and data of interest, and then either generate CDC reports 15. Alternatively, the same physician may add to the data in the form of comments and other medical facts data 16, package and encrypt an individual CDC or CDC set 17, or into a local CDC repository 18, for distribution to other physicians, for example, consulting physicians. Alternatively, the CDCs may be provided to the individual patient on a CD Rom, or other standard medium, along with a certain software package bundled with a viewer so the patient may view his or her medical information.

The present invention advantageously provides to maintain a sequence or a set of medical documents either for one or several patients, and longitudinally over time provide the ability to track the progress of a patient and the information provided about the patient. This allows near real time treatment orientation by multiple physicians in multiple locations.

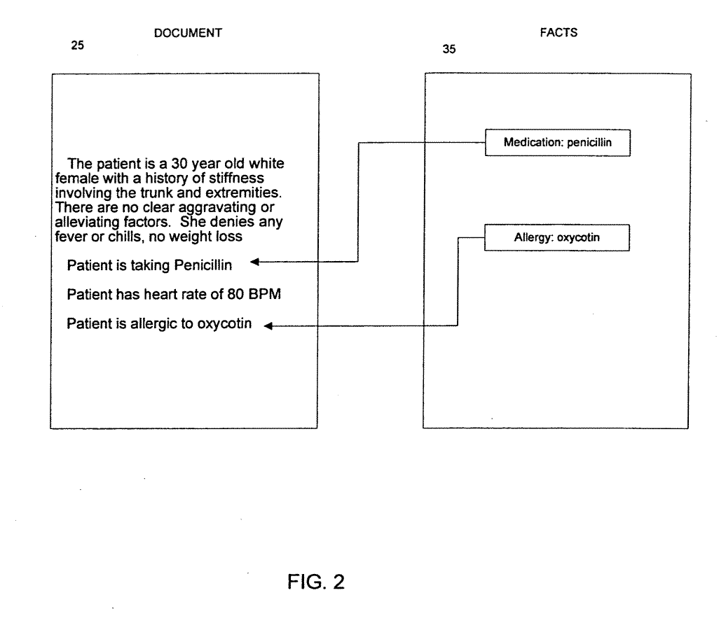

Referring now to FIG. 2 there is shown a representation of how an NLPR document relates to the entire set of CCR facts. The NLPR system extracts medically relevant facts from a document and creates metadata which represents those facts and links those facts to locations within the document to which those facts are associated. Some of these facts are facts that are relevant for embedding within, or encapsulation within the CCR. A free standing NLPR processed document 25 and the embedding of the medical facts 35 that have been extracted by NLPR within the CCR along with the links from those facts to the relevant or associated locations within the NLPR document. Also demonstrated is the element that there are other slots that are not extracted or handled by NLPR. \The NLPR system functions properly in this connection because some, but not all of the information in NLPR is relevant to or can actually be found in the CCR record.

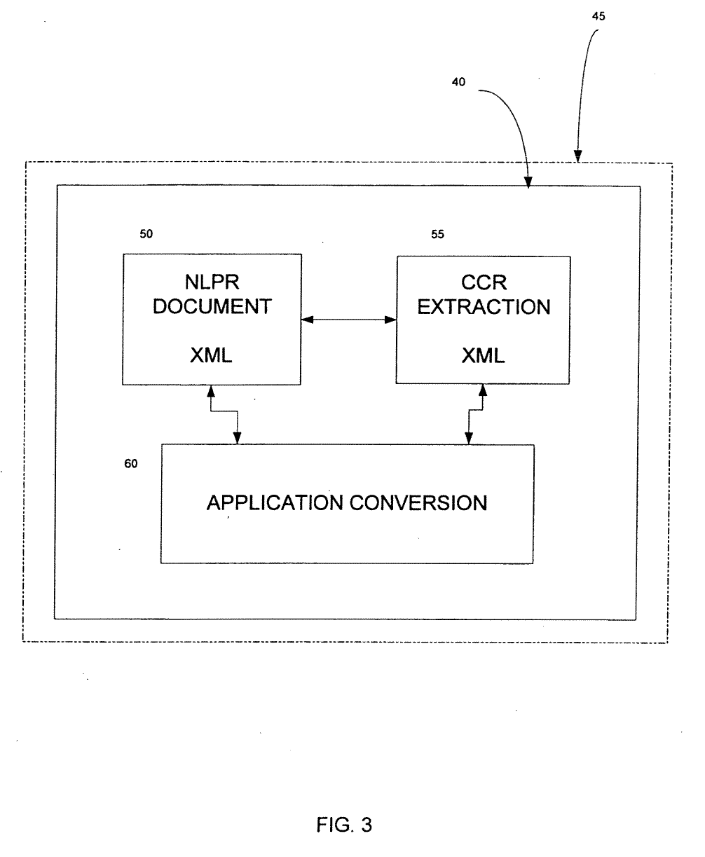

Referring now to FIG. 3 there is shown a representation of the CDC container 40. The CDC container 40 may include three objects: an NLPR document 50 preferably embodied in some form of XML, a CCR extraction 55, also preferably embodied in a standardized form of XML. The NLPR document also preferably is embodied using a CD A standard representation.

There are also associated links between XML documents 50 and 55 because, as we generally noted above in FIG. 2, there are general relationships between the document 25 and the extraction35. More specifically there are certain facts which are actually cross-referenced to the document that are located the CCR and are cross-referenced to the NLPR document. Lastly, within the CDC container 40 there is also exists a resident application-relevant data conversion. The XML information is converted to an application-relevant format, for example, PDF, which may be displayed, printed, or viewed at a later time. The CDC container 45 is encapsulated in an encryption layer 45.

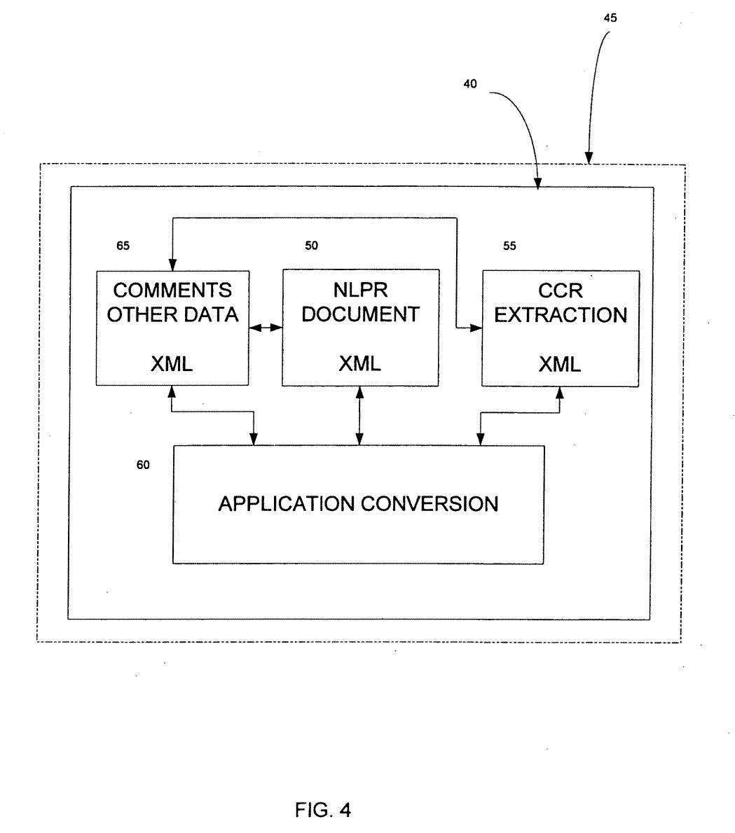

Referring now to FIG. 4 there is shown is another a representation of the CDC container 40. CDC container 40 in FIG. 4 also may include an additional XML labeled 65 which is for comments and other data. These comments and other data 65 are linked to the application conversion as well XML documents 50 and 55.

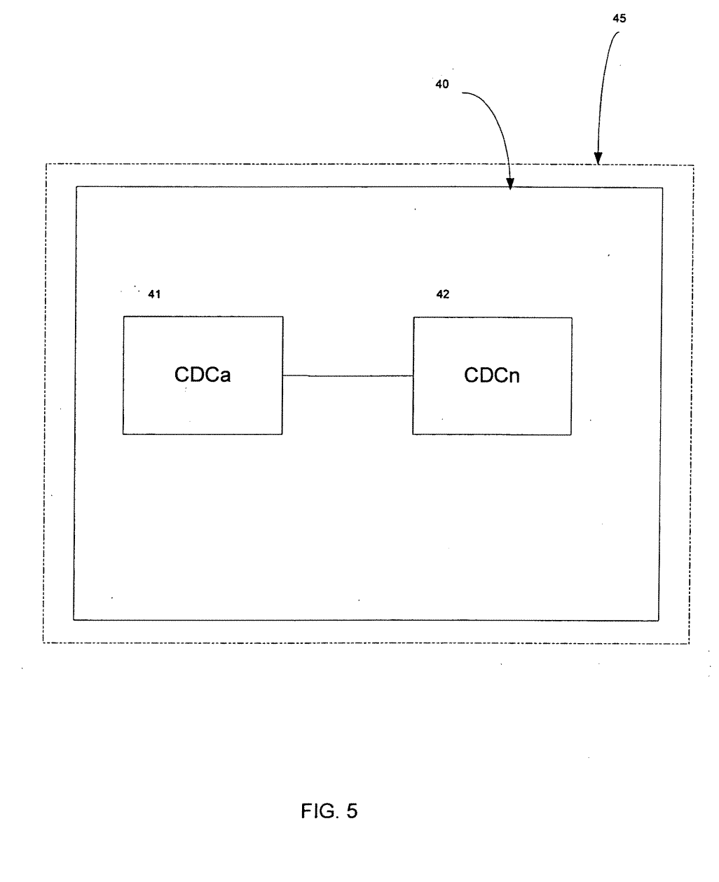

FIG. 5 shows the encapsulation of multiple CDCs, CDCa up to CDCn, in a layer if encryption 45. This shows that multiple CDCs may be transferred under the umbrella of encryption.

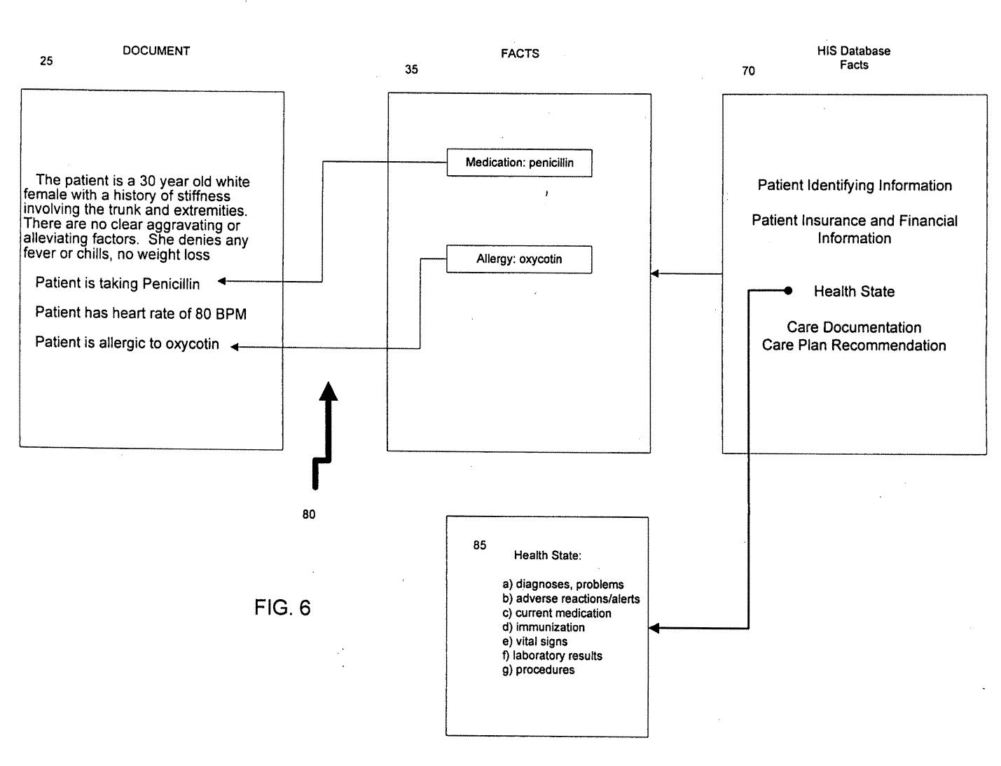

Referring now to FIG. 6 there is shown a larger view of CDC landscape as shown in FIG. 2. It can be seen from FIG. 6 that data provided in a CDC, the container itself, may be derived from multiple sources, namely, an NLPR system and a Health Information Management System (HIS) source. On the one hand side the NLPR derived consists of a document and its metadata with links between the two, which is represented accurately in FIG. 2. Also represented in FIG. 6 are the facts that are incorporated in the CDC may include a compilation of data that comes from the NLPR as well as data from the other sources. Some of that data, for example, the HIS derived data 70, may include the continuity of care documentation and the care plan recommendation can. Further, a series of sub-categories under health status 85, for example, may include diagnoses, problems, adverse reactions, alerts, current medications, immunizations, vital signs, laboratory results and procedures, assessments. Three major categories of health status, care documentation and care plan recommendation may also, in some hospital environments come directly from a respective HIS system. Alternatively, hospital system may include additional information that might come out of that system to complement the information derived from the NLPR system. On the other hand, the hospital administrators, to comply with requirement of a CCR, may only have health status, care documentation and care plan recommendation. Additional patient relevant fields may include metadata representing patient identification information, for example, the patient's insurance and financial information. These are all categories of information whether derived from the NLPR or from the HIS, that are categories of data that are described within the CCR and which are embedded within the system and which will be embedded within the harmonized CDA to will allow for an XML representation of the patient data which has been completely allied with CDA grammar and XML grammar. The present invention advantageously provides the merging of the information from two sources and the merging of that information in a single fact base where there are relationships in some cases in that fact base to the document proper, or documents proper, as NLPR documents have relationships to some of the facts, or the facts have some relationships to some of the NLPR text segments.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

For the convenience of the reader, the above description has focused on a representative sample of possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

What is claimed is:

1. A method for distributing shared medical information relating to a patient, the method comprising the steps of:
obtaining a medical document processed through a natural language processing system, said document having corresponding associated medical facts related to said patient;
obtaining an healthcare information system data set;
extracting a set of data elements from said document and its corresponding associated medical facts and from said healthcare information system data set according to a first pre-defined standard;
formatting said medical document into a second predefined standard;
formatting said extracted data elements according to the first predefined standard;
converting said formatted medical document and said formatted extracted data elements into a predefined application format;
obtaining additional documents related to said patient;
merging said additional documents with said application format;
encrypting said additional documents and application format; and
distributing said additional documents and application format.

2. The method according to claim 1, wherein said first predefined standard is a CCR standard.

3. The method according to claim 2, wherein said second predefined standard is a CDR standard.

4. A method for distributing a set of documents related to a patient bundled with associated facts to a user, the method comprising the steps of:
selecting a document transcribed from an audio file created by said user;
determining associated facts corresponding to said document:
defining a single format suitable for packaging said document and the associated facts;
encapsulating said document and the associated facts in said single format;
obtaining additional documents related to said patient;
merging said additional documents with said encapsulated document and the associated facts into a set of documents;
transporting said set of documents to said user;
collecting and storing sets of document packages in a repository;
searching said repository;
generating reports from the results of said search;
adding metadata to the results of said searches; and
encapsulating, encrypting, and distributing said sets of document package.
